(19) United States
(12) Patent Application Publication
(10) Pub. No.: US 2014/0372275 A1
(43) Pub. Date: Dec. 18, 2014

(54) METHOD AND SYSTEM FOR PERFORMING AN OPENING AUCTION OF A DERIVATIVE

(71) Applicant: Deutsche Börse AG, Frankfurt AM MAIN (DE)

(72) Inventors: Thomas Winter, Frankfurt am Main (DE); Johannes Müller, Nürnberg (DE); Alexander Martin, Nürnberg (DE); Susanne Papa, Erlangen (DE); Andrea Peter, Darmstadt (DE); Sebastian Pokutta, Hannover (DE)

(21) Appl. No.: 13/920,041

(22) Filed: Jun. 17, 2013

(51) Int. Cl. G06Q 40/00

(52) U.S. Cl. CPC G06Q 40/04
USPC 705/37

(57) ABSTRACT

A method for determining execution states, market clearing prices and bid and ask prices for futures products at an opening auction. A plurality of orders is received, each order is associated with a price limit, a quantity, a participant and a futures product. For each order a quantity vector is determined, is based on the futures product associated with the order. Further, for each order a price vector is determined, based on the price limit and the futures product associated with the order. Then, an execution state vector is determined by using the determined price and quantity vectors to maximize an objective function subject to constraints. Market clearing prices and best, not executed, buy and sell orders are determined for each product using the execution state vector. Finally the bid and ask prices are given by the price limits of the best, not executed, buy and sell orders.

### BACKGROUND OF THE INVENTION

1. Field of the Invention

The invention relates to data processing apparatus and methods and, more particularly, to performing an opening auction of a derivative.

2. Description of Related Art

Derivates such as futures or options have become increasingly important in the world of finance. Futures and options are now traded actively on many exchanges throughout the world. A derivative is a financial instrument whose value depends on or derives from the values of other, more basic underlying variables. Very often, the variables underlying derivatives are the prices of traded assets. A stock option, for example, is a derivative whose value is dependent on the price of a stock.

A derivative exchange is a market where individuals trade standardized derivatives contracts that have been defined by the exchange. Traditionally, derivatives traders have met on the floor of an exchange and used shouting and a complicated set of hand signals to indicate the trades they would like to carry out. This is known as the open outcry system. In recent years, exchanges have increasingly moved from the open outcry system to electronic trading.

A futures contract (also referred to as contract) is an agreement between two parties to buy or sell an asset at a certain time in the future for a certain price. Futures contracts are normally traded on an exchange such as the Eurex. Each contract is associated with an expiry date.

Generally, there are different kinds of contracts, reflecting the different kinds of tradable assets (also denoted as underlying in the context of derivatives) on which the contract may be based. Underlyings of an contract may be, for instance, commodities, securities such as stocks, bonds, currencies or intangibles, such as interest rates and indexes. Futures or options on currencies, financial securities or on financial indices are also called financial futures or financial options, respectively.

A futures contract combination (also referred to as combination) allows for swapping one futures contract by another futures contract. There are different kinds of futures contract combinations. For instance, a first kind of futures contract combination is a time spread which allows for swapping two futures contracts with the same underlying but with different expiry dates. A further kind of a futures combination contract is an inter-product spread which allows for swapping two futures contracts with different underlyings but not necessarily different expiry dates.

Every trading day, before starting the continuous trading of derivatives, the opening price of each tradable product is determined in an opening auction. Besides different products such as futures contracts or futures contracts combinations, there exist two different order types in the opening auction: limit orders and market orders. If a participant submits a limit order, then he has to specify the product he wants to buy or sell, the quantity, and the price limit. The price limit specifies the highest price per unit that a buyer is willing to pay or the lowest price per unit that a seller wants to receive.

If a participant submits a market order, then he has to specify the product and the quantity that he wants to buy. Market Orders have a higher priority than limit orders and the trader is accepting all prices. In an opening auction a market order can be treated like a limit order with the highest feasible price limit if it is a buy order, or the lowest feasible price limit if it is a sell order. Partial execution of limit orders or market orders is feasible if the limit price coincides with the market price.

A futures opening auction is a combinatorial auction. A good survey about this topic is written by De Vries and Vohra: “Combinatorial Auctions: A Survey”, INFORMS Journal on Computing, 15(3), pages 284 to 309, 2003, ISSN 1526-5528, which is incorporated by reference. The authors point out that there exist combinatorial auctions that can be solved in polynomial time. This is for example the case if the constraint matrix is total unimodular and the right hand side is integral. Two useful special cases of total unimodular matrices are node-arc-incidence matrices and matrices that satisfy the consecutive-ones property (in each column non-zero entries are equal to one and occur consecutively). The authors suggest choosing a bidding language that admits a good formulation of the problem. The authors also point out that there are situations where the constraint matrix of an auction can be interpreted as a graph. Each row represents a node (good) and each column represents an arc (order).

The price for a futures combination product should be the price difference of the two involved futures contracts. In prior art techniques for performing opening auctions this constraint is in some cases not satisfied such that the prices of the different products are inconsistent. Further, prior art techniques for determining opening prices at an opening auction are computational complex and time consuming.

### SUMMARY OF THE INVENTION

According to an embodiment, a computer implemented method for determining execution states, market clearing prices and bid and ask prices for futures products at an opening auction is provided. A futures product is one of a sell futures contract, a buy futures contract, a sell futures contract combination and a buy futures contract combination. A plurality of orders is received, wherein each order is associated with a price limit, a quantity, a participant and a futures product. For each order a quantity vector is determined, wherein the quantity vector is based on the futures product associated with the order. Further, for each order a price vector is determined, wherein the price vector is based on the price limit associated with the order and the futures product associated with the order. Then, an execution state vector is determined by using the determined price and quantity vectors to maximize an objective function subject to constraints. The objective function is based on an executed volume and at least one of the constraints depends on the determined quantity vectors. Market clearing prices and best, not executed, buy and sell orders are determined for each futures product using the execution state vector. Bid and ask prices for each futures product are given by the price limits of the best, not executed, buy and sell orders of the respective product. Finally the execution state vector, the market clearing prices and the bid and ask prices are output.

According to another embodiment, a non-transitory and tangible computer-readable medium is provided that has computer-executable instructions that, when executed by a computer, cause the computer to perform a method for determining execution states, market clearing prices and bid and ask prices for futures products at an opening auction. A futures product is one of a sell futures contract, a buy futures contract, a sell futures contract combination and a buy futures contract combination. A plurality of orders is received, wherein each order is associated with a price limit, a quantity, a participant and a futures product. For each order a quantity vector is determined, wherein the quantity vector is based on the futures product associated with the order. Further, for each order a price vector is determined, wherein the price vector is based on the price limit associated with the order and the futures product associated with the order. Then, an execution state vector is determined by using the determined price and quantity vectors to maximize an objective function subject to constraints. The objective function is based on an executed volume and at least one of the constraints depends on the determined quantity vectors. Market clearing prices and best, not executed, buy and sell orders are determined for each product using the execution state vector. Bid and ask prices for each futures product are given by the price limits of the best, not executed, buy and sell orders of the respective futures product. Finally the execution state vector, the market clearing prices and the bid and ask prices are output.

Finally, a computer system is provided which comprises at least one memory having stored computer-executable instructions and at least one processor which is configured for executing the stored computer-executable instructions. The computer-executable instructions cause the processor to perform a method for determining execution states, market clearing prices and bid and ask prices for futures products at an opening auction is provided. A futures product is one of a sell futures contract, a buy futures contract, a sell futures contract combination and a buy futures contract combination. A plurality of orders is received, wherein each order is associated with a price limit, a quantity, a participant and a futures product. For each order a quantity vector is determined, wherein the quantity vector is based on the futures product associated with the order. Further, for each order a price vector is determined, wherein the price vector is based on the price limit associated with the order and the futures product associated with the order. Then, an execution state vector is determined by using the determined price and quantity vectors to maximize an objective function subject to constraints. The objective function is based on an executed volume and at least one of the constraints depends on the determined quantity vectors. Market clearing prices and best, not executed, buy and sell orders are determined for each product using the execution state vector. Bid and ask prices for each futures product are given by the price limits of the best, not executed, buy and sell orders of the respective futures product. Finally the execution state vector, the market clearing prices and the bid and ask prices are output.

### BRIEF DESCRIPTION OF THE DRAWINGS

The accompanying drawings are incorporated into and form a part of the specification for the purpose of explaining the principals of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1 visualizes the notation of futures products according to embodiments;

FIG. 2 illustrates a method for determining prices of futures products at an opening auction according to embodiments; and

FIG. 3 illustrates a schematic block diagram of a computer architecture for performing the disclosed methods according to embodiments.

### DETAILED DESCRIPTION OF THE INVENTION

The illustrative embodiments of the present invention will be described with reference to the figure drawings wherein like elements and structures are indicated by like reference numbers.

The present invention provides a natural formulation for a futures opening auction (also referred to as the futures opening auction problem). A futures opening auction is formulated as a min cost flow model. The price conditions of limit orders for contracts and contract combinations may be introduced into the model by choosing the right objective function. The inventive objective function automatically yields the desired equilibrium conditions for the model. The desired equilibrium conditions are: the order books are uncrossed, no further combinatorial matching cycle exists, and there is a bid ask spread.

The invention provides for several advantages. On the one hand, the model is solvable in polynomial time with a standard solver and the computing times are sufficiently fast enough for the use in production environments. On the other hand the model is very flexible: in contrast to prior art models it is not restricted to a limited number of different contracts. The model is even capable to solve the opening auction problem for contracts with several different underlyings at once.

Another important advantage is that the economic surplus of all participants gets maximized. It is not possible to find a solution with a higher economic surplus. One consequence of a maximized economic surplus is that all heuristic solutions generate a lower or equal economic surplus. For instance, the current algorithm at EUREX is a heuristic and therefore generates in general a lower economic surplus: at first prices are determined for each contract separately. At that time the prices can be inconsistent in reference to the combination orders. Then the combination orders get triggered according to the prices of the underlying contracts. When the algorithm finishes the prices are consistent again. Another consequence of a maximized economic surplus is a good price quality: at any time the prices for contracts are consistent with the prices for combinations.

A mathematical model describing a real-world scenario such as a futures opening auction usually describes a system by a set of variables and a set of equations and inequalities. Rules establish relationships between the variables and/or defining conditions for the variables. An optimal solution to the mathematical model is a set of variable values which maximizes an objective function and satisfies each equation and inequality building the mathematical model. The present invention aims at providing an algorithm which finds an optimal solution for a model of a futures opening auction in an efficient, reliable and fast manner.

The present invention may be operational with numerous general purpose or special purpose computing systems environments or configurations. Examples of well known computing systems, environments and/or configurations that may be suitable for use with the invention may include, but are not limited to, personal computers, server computers, handheld or laptop devices, embedded systems, multi-processor systems, micro-processor based systems, network PCs, mini-computers, tablet computers, smartphones, mainframe computers, distributed computing environments that include any of the above system or devices, and the like.

The invention may be described in the general context of computer-executable instructions, such as program modules, being executed by a computer. Generally, program modules include routines, programs, objects, components, data structures, et cetera that perform particular tasks or implement particular abstract data types. The general purpose or special purpose computing system environments or configurations may be programmable using a high level computer programming language. In some embodiments, the general purpose or special purpose computing system environments or configurations may also use specially programmed, special purpose hardware.

As already mentioned, the invention may also be practiced in distributed computing environments where tasks are performed by remote processing devices that are linked through a communication network. In a distributed computing environment, program modules may be located in both local and remote computer storage media including memory storage devices.

To find a suitable notation for formulating a model for an opening auction for futures products, let for the present invention T be the set of the different contracts in a futures opening auction. As known to a person skilled in the art, a contract is characterized by its underlying asset and its expiry date. Two contracts are equal if they have the same underlying asset and the same expiry date. Further, suppose that the contract set T is a totally ordered set sorted in ascending order where the first sort criterion is the underlying asset id and the second criterion is the expiry date.

According to embodiments, the contracts are considered to be nodes in a graph and the orders are considered to be directed arcs connecting the nodes. To be able to model all trading products, a super node ∘ is defined that represents the source and sink of futures products that only involve one futures contract. Let T′=T∪{∘} be the extended node set (also referred to as contract set), where ∘ is appended to the end of the sorted set. Then the set of trading products C is a subset of arcs in T′×T′. The arc (i,j)εT′×T′ represents the product “demand contract i and offer contract j”.

According to embodiments, the futures product (i,j)εT′×T′ is a buy product if i<j. If i>j, then it is a sell product. Note that i<∘ for all iεT.

The basic futures products are denoted as follows:
(i,∘)εC: buy futures contract i: demand contract i;
(∘,j)εC: sell futures contract j: offer contract j;
(i,j)εC with (i<j): buy futures contract combination i,j: demand contract i and offer contract j; and
(j,i)εC with (i<j): sell futures contract combination i,j: demand contract j and offer contract i.

The super node ∘ is only used to visualize products and orders in a graph. This node is omitted in the below described model representation of the network flow model (referred to as LP), as the flow conservation equation of the super node is a redundant equation and is a source of degeneracy in the dual LP.

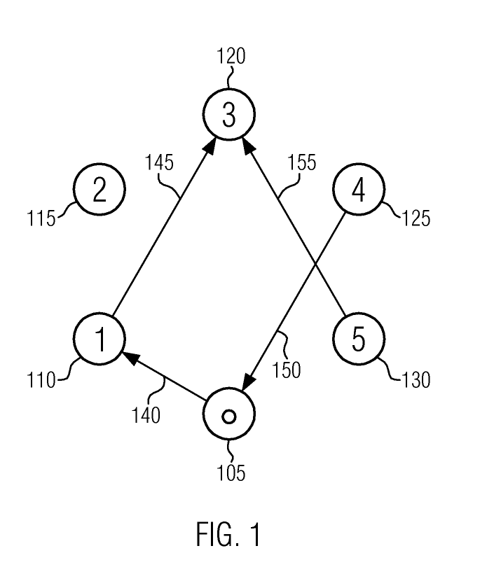

To further explain the visualization of orders according to embodiments, it is now referred to FIG. 1. Consider as an example a set T={1,2,3,4,5}. Each of the nodes 110, 115, 120, 125 and 130 is labeled with a number. Nodes 110, 115, 120, 125 and 130 are labeled with 1, 2, 3, 4 and 5 to indicate the ordered contracts 1, 2, 3, 4 and 5, respectively. Node 105 is labeled with ∘ to indicate that this node represents the above introduced super node. For a futures product, the contract 1 may be associated with an expiration date nearest to the date of a current trading day, while the contract 5 may be associated with an expiration date farthest from the date of the current trading day. The expiration date of contracts 2, 3 and 4 may lie between those expiration dates wherein an ascending number indicates an higher expiration date.

Generally, a notation for an order (buy contract i, sell contract j) may be (i,j) with (i,j)εT′×T′,i≠j. As explained above, an order of buy futures contract combination i,j may be written as (i,j), wherein i is smaller than j. An order of sell futures contract combination i,j may be written as (j,i), wherein i is smaller than j. Thus, for futures products of the example contract set T={1,2,3,4,5}, edge 145 is a buy order of futures contract combination 1,3, which is written as (1,3) and edge 155 is a sell order of futures contract combination 3,5 and is written as (5,3).

The edge 140 is a sell order of futures contract 1 which is written as (∘,1) and edge 150 is a buy order of futures contract 4 which is written as (4,∘).

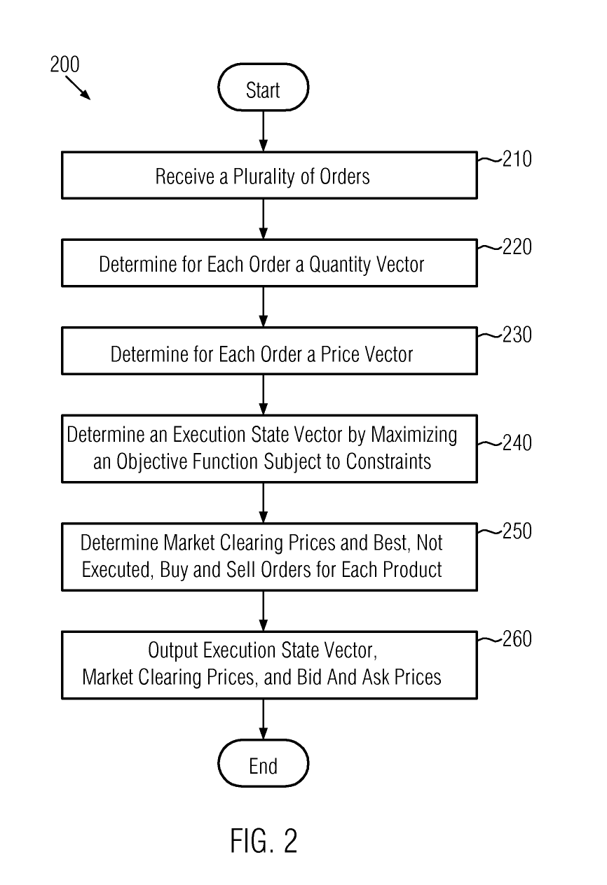

Turning now to FIG. 2 which illustrates a method for determining bid and ask prices for futures products at an opening auction, wherein a futures product during the opening auction may be a sell futures contract, a buy futures contract, a buy futures contract combination or a sell futures contract combination.

At step 210, a plurality of orders may be received. Each of the plurality of orders may be associated with a price limit, a quantity, a participant and a futures product.

At step 220, a quantity vector is determined for each received order. Specifically, for a given order, the quantity vector is based on the futures product associated with the given order.

Discussing step 220 in greater detail, let for the present invention B be the set of limit orders (and market orders since, as outlined above, in an opening auction a market order can be treated like a limit order with the highest feasible price limit if it is a buy order, or the lowest feasible price limit if it is a sell order) received at step 210. To model an order bεB, the parameters q_{b,t} with tεT may be used. The parameter q_{b,t} is the t-th entry of the quantity vector q_{b,T} of the futures product associated with order b. Let (i,j) be the product associated with order bεB, then the entries of the quantity vector may be determined for all tεT as follows:

$${q}_{b , t} ∈ \{ - 1 , 0 , 1 \} , \\ wherein {q}_{b , t} = \{ \begin{matrix}+ 1 & if t = i ( demand contract i ) \\ - 1 & if t = j ( offer contract j ) \\ 0 & otherwise\end{matrix} .$$

At step 230, a price vector is determined for each received order. Specifically, for a given order, the price vector is based on the price limit associated with the given order and the futures product associated with the given order.

Discussing step 230 in greater detail, to model the order bεB, the parameters p_{b,t} with tεT may be used. p_{b,t} is the t-th entry of a price vector p_{b,T} that represents the price limit of order b. Let (i,j) be the product associated with b and let k=min{i,j} be the smallest index, then the price vector vanishes at the entries T\{k} and the entry p_{b,k} is the price limit of order b. Let (i,j) be the product associated with order bεB, then the entries of the price vector may be determined for all tεT as follows:

$${p}_{b , t} ∈ ℤ , \\ wherein {p}_{b , t} = \{ \begin{matrix}price limit of order b & if t = min \{ i , j \} \\ 0 & otherwise\end{matrix} .$$

As further input parameter to the model u_{b}ε [symbol] may be defined at any of steps 210, 220 or 230. u_{b} represents the maximal demanded or offered quantity associated with order bεB.

To further understand steps 220 and 230, consider the following example. Suppose that there exist three different contracts T={1,2,3}. An order bεB for the product (1,∘) (buy contract 1) with limit price 40 is modeled as follows:

q_{b,•}=(1 0 0) p_{b,•}=(40 0 0).

And an order cεB for the product (∘,2) (sell contract 2) with limit price 53 is characterized by

q_{c,•}=(0 −1 0) p_{c,•}=(0 53 0).

Whereas an order dεB for the product (1,2) (buy combination 1,2=buy contract 1 and sell contract 2) with a minimal spread of at least 13 currency units may be modeled by directly involving the minimal spread

q_{d,•}=(1 −1 0) p_{d,•}=(−13 0 0).

Alternatively reference prices may be used for the two underlying contracts

q_{d,•}=(1 −1 0) p_{d,•}=(40 53 0).

The negative price limit indicates that the buyer wants to receive at least 13 currency units.

One can see from the examples that if a single buy or sell order is modeled, then the quantity vector and the price vector vanish at all but one entry. If a futures contract combination order is modeled, being a linear combination of a single buy and a single sell order, then the quantity vector vanishes at all but two entries. As order d is a linear combination of order b and c one may write q_{b,•}+q_{c,•}=q_{d,•} and p_{b,•}+p_{c,•}=p_{d,•}.

Returning to FIG. 2, at step 240, an execution state vector is determined by using the determined price and quantity vectors to maximize an objective function subject to constraints. The objective function is based on an executed volume and at least one of the constraints depends on the quantity vectors determined at step 220.

To determine the objective function and the constraints, firstly consider a complete model (referred to as MIP) that covers all market requirements and guarantees consistent prices. The objective is the maximization of the executed volume

$${\sum }_{b ∈ B} {β}_{b}$$

subject to the price constraints given by the limit prices of all limit orders, wherein the execution state of order b is represented by a non-negative integer variable β_{b} and wherein the market clearing price per unit for contract tεT is modeled by an integer variable πₜ:

$$\begin{matrix}max {\sum }_{b ∈ B} {β}_{b} & ( MIP ) \\ \begin{matrix}s . t . ( subject to ) & ∀ t ∈ T {\sum }_{b ∈ B} {q}_{b , t} {β}_{b} = 0 & clearing constraint\end{matrix} & ( 1 ) \\ \begin{matrix}∀ b ∈ B {β}_{b} > 0 ⇒ {\sum }_{t ∈ T} ( {p}_{b , t} - {π}_{t} ) {q}_{b , t} \geq 0 & price condition\end{matrix} & ( 2 ) \\ \begin{matrix}∀ b ∈ B {β}_{b} < {u}_{b} ⇒ {\sum }_{t ∈ T} ( {p}_{b , t} - {π}_{t} ) {q}_{b , t} \leq 0 & price condition\end{matrix} & ( 3 ) \\ \begin{matrix}∀ b ∈ B 0 \leq {β}_{b} \leq {u}_{b} & quantity restriction\end{matrix} & ( 4 ) \\ \begin{matrix}∀ b ∈ B {β}_{b} ∈ ℤ & integrality condition\end{matrix} & ( 5 ) \\ \begin{matrix}∀ t ∈ T {π}_{t} ∈ ℤ & price variable\end{matrix} & ( 6 ) \\ wherein \\ {β}_{b} = \{ \begin{matrix}{u}_{b} \text{:} b is completely executed \\ otherwise \text{:} b is partially executed \\ 0 \text{:} b is not executed .\end{matrix} & \end{matrix}$$

Equations (2) and (3) are so called indicator constraints and can be modeled with linear constraints by using a Big-M formulation, which is a conventional modeling technique. According to the invention, it is not necessary to model them at all.

The market clearing prices for combinations are given by the difference of the prices of the two underlying contracts. Therefore, it is not necessary to model them explicitly.

According to an embodiment, to solve this problem, (MIP) may at first be relaxed. The integrality of the execution variables β may be relaxed, as well as the price conditions (order price limits) may be relaxed. In addition, the objective function may be replaced so that the economic surplus

$${\sum }_{b ∈ B} {β}_{b} {\sum }_{t ∈ T} {p}_{b , t} {q}_{b , t}$$

of all participants may be maximized instead of the execution volume (this optimization problem will be referred to as LP1)

$$\begin{matrix}max {\sum }_{b ∈ B} {β}_{b} {\sum }_{t ∈ T} {p}_{b , t} {q}_{b , t} & \\ s . t . [ π ] ∀ t ∈ T {\sum }_{b ∈ B} {q}_{b , t} {β}_{b} = 0 & clearing constraint \\ [ \overline{v} ] ∀ b ∈ B {β}_{b} \leq {u}_{b} & quantity restriction \\ [ \underline{v} ] ∀ t ∈ B - {β}_{b} \leq 0 & quantity restriction\end{matrix} \qquad ( LP 1 )$$

The variables in square brackets denote dual variables of the corresponding primal constraints.

It is known to a skilled person that a matrix of integers is said to be totally unimodular if every square submatrix has determinant 0, +1, or −1. Further it is known that a polyhedron has the integral property if and only if every minimal face contains an integral point. In addition, the person skilled in the art knows that a matrix A of integers is totally unimodular if and only if {x|b≦Ax≦b′ and c≦x≦c′} has the integral property for all vectors b,b′,c,c′, whose components are integers, +∞, or −∞.

By construction, the matrix q is a node-arc-incidence matrix of a directed graph and it is known that node-arc-incidence matrices are totally unimodular. Accordingly, as the polyhedron of (LP1) is bounded, all boundary points are integral. In particular all boundary points of (LP1) that maximize the objective are integral.

To analyze the properties of such an optimal boundary point β*, the Karush-Kuhn-Tucker optimality conditions (Appendix, cf. S. Boyd and L. Vandenberghe: “Convex Optimization”, Cambridge University Press, 2004, ISBN 0521833787, which is hereby incorporated by reference) may be applied. The result is that given an integral optimal solution β* to (LP1) there exist prices π such that (β*,π) is feasible for (MIP):

Specifically, let β* be integral and primal optimal to (LP1), then there exist dual variables π, ν̅ and ν that satisfy equations (7) to (10).

$$\begin{matrix}\begin{matrix}∀ b ∈ B & - {\sum }_{t ∈ T} {p}_{b , t} {q}_{b , t} + {\sum }_{t ∈ T} {q}_{b , t} {π}_{t} + ( {\overline{v}}_{b} - {\underline{v}}_{b} ) = 0\end{matrix} & ( 7 ) \\ \begin{matrix}∀ b ∈ B & {\overline{v}}_{b} , {\underline{v}}_{b} \geq 0\end{matrix} & ( 8 ) \\ \begin{matrix}∀ b ∈ B & ( {β}_{b}^{*} - {u}_{b} ) {\overline{v}}_{b} = 0\end{matrix} & ( 9 ) \\ \begin{matrix}∀ b ∈ B & ( - {β}_{b}^{*} ) {\underline{v}}_{b} = 0\end{matrix} & ( 10 )\end{matrix}$$

This condition is equivalent to the following one: There exist prices π so that equations (11) and (12) hold.

$$\begin{matrix}\begin{matrix}∀ b ∈ B & {β}_{b}^{*} > 0 ⇒ {\sum }_{t ∈ T} ( {p}_{b , t} - {π}_{t} ) {q}_{b , t} \geq 0\end{matrix} & ( 11 ) \\ \begin{matrix}∀ b ∈ B & {β}_{b}^{*} < {u}_{b} ⇒ {\sum }_{t ∈ T} ( {p}_{b , t} - {π}_{t} ) {q}_{b , t} \leq 0\end{matrix} & ( 12 )\end{matrix}$$

These equations coincide with price conditions (2) and (3). An optimal integral solution to (LP1) satisfies the price conditions and, therefore, is feasible for (MIP). And vice versa, a feasible solution for (MIP) is optimal for (LP1), as it satisfies the price condition and thereby maximizes the economic surplus of all participants (cf. Karush-Kuhn-Tucker optimality conditions).

Now, according to an embodiment of the invention, a feasible solution to (MIP) may be characterized as follows: any integral point of (LP1) that maximizes the economic surplus is feasible to (MIP). As the polyhedron of (LP1) is integral, also the polyhedron of optimal solutions is integral. Hence, the execution volume subject to the constraints of (MIP) may be maximized by using a linear program (referred to as LP2) where the economic surplus is fixed to its optimal value. Thus, a fixed optimal solution β* to (LP1) may be used to fix the economic surplus to its optimal value.

$$\begin{matrix}max {\sum }_{b ∈ B} {β}_{b} & \\ s . t . ∀ t ∈ T {\sum }_{b ∈ B} {q}_{b , t} {β}_{b} = 0 & clearing constraint \\ ∀ b ∈ B {β}_{b} \leq {u}_{b} & quantity restriction \\ ∀ b ∈ B - {β}_{b} \leq 0 & quantity restriction \\ {\sum }_{b ∈ B} {β}_{b} {\sum }_{t ∈ T} {p}_{b , t } {q}_{b , t} = {\sum }_{b ∈ B} {β}_{b}^{*} {\sum }_{t ∈ T} {p}_{b , t } {q}_{b , t} & \begin{matrix}optimality of economic \\ surplus\end{matrix}\end{matrix} \qquad ( LP 2 )$$

Hence, according to embodiments, an optimal solution to (MIP) may be constructed by firstly finding an optimal solution β* to the linear program (LP1). Then (LP2) may be solved by using β* as input to fix the economic surplus to the optimal value. An optimal boundary point of (LP2) is feasible and optimal to (MIP).

According to an alternate embodiment, to find a solution for (MIP), (LP1) and (LP2) are not solved successively, but (LP1) and (LP2) are incorporated into one new problem, referred to as (LP3).

To construct (LP3), consider that each component of p and q is integral. If a solution β* is integral, then the objective of (LP1) is also integral. The objective of (LP2) (volume maximization) can be strictly bounded by V:=1+Σ_{bεB}u_{b}. For (LP3), a new objective function that is given by V times the objective of (LP1) (surplus maximization) plus the objective function of (LP2) may be defined:

$$V {\sum }_{b ∈ B} {β}_{b} {\sum }_{t ∈ T} {p}_{b , t } {q}_{b , t} + {\sum }_{b ∈ B} {β}_{b} . \qquad ( 13 )$$

To arrive at (LP3), the objective in (LP1) is replaced with objective (13). An optimal solution to the resulting (LP3) will be optimal to (LP1) and (LP2) and thus optimal to (MIP).

Thus, the linear program (LP3) may be:

$$\begin{matrix}max {\sum }_{b ∈ B} ( 1 + V {\sum }_{t ∈ T} {p}_{b , t} {q}_{b , t} ) {β}_{b} \\ s . t ∀ t ∈ T {\sum }_{b ∈ B} {q}_{b , t} {β}_{b} = 0 \\ ∀ b ∈ B 0 \leq {β}_{b} \leq {u}_{b}\end{matrix} \qquad ( LP3 )$$

At step 250, the market clearing prices and the best, not executed, buy and sell orders for each product may be determined. Specifically, let β* be an optimal solution to (LP3), which is also optimal to (LP1), (LP2) and (MIP). Then the following (LP4) will provide market clearing prices π for all contracts.

$$∀ b ∈ B with {β}_{b}^{*} > 0 {\sum }_{t ∈ T} ( {p}_{b , t} - {π}_{t} ) {q}_{b , t} \geq 0 \\ ∀ b ∈ B with {β}_{b}^{*} < {u}_{b} {\sum }_{t ∈ T} ( {p}_{b , t} - {π}_{t} ) {q}_{b , t} \leq 0 \qquad ( LP4 )$$

The prices π are called market clearing prices. The market clearing prices determine the amount of money a participant has to pay or receive for the execution of his order. The net amount of money the participant has to pay or receive is given by

$$- {β}_{b}^{*} {\sum }_{t ∈ T} {π}_{t} {q}_{b , t} .$$

If this amount is positive, the participant will receive money, otherwise the participant has to pay money.

The bid and ask prices for each futures product may be computed by selecting the best, not executed buy and sell orders of the respective futures product. This may be done in linear time by iterating a single time through all orders. Then, the bid and ask prices for each futures product are given by the price limits of the best, not executed, buy and sell orders of each futures product.

At step 260, the determined results may be output. Specifically, the determined execution states β* (also referred to as execution state vector), market clearing prices π and bid and ask prices may be the results of the opening auction.

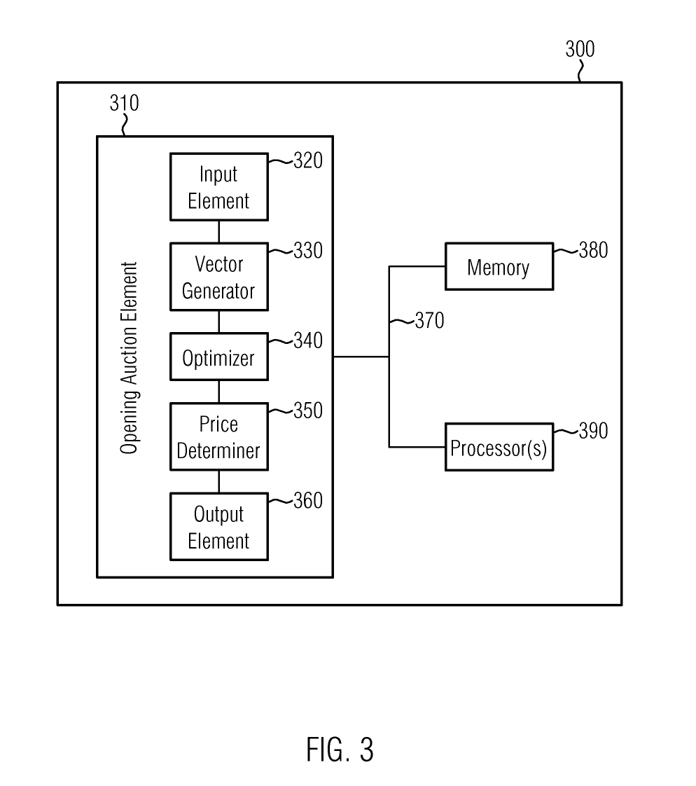

Turning to FIG. 3, this Figure illustrates computer architecture 300 for carrying out the method disclosed with respect to FIG. 2. The computer architecture may include one or more computing devices having one or more processors 390. Instructions are recorded on tangible media and are executed by the one or more processors 390 to carry out the disclosed functions. The architecture includes an opening auction element 310 and a memory 380. The opening auction element 310 may further include an input element 320, a vector generator 330, an optimizer 340, a price determiner 350 and/or an output element 360. All elements 310, 320, 330, 340, 350 and 360 communicate with memory 380 and the one or more processors 390 via bus 370. The steps of FIG. 2 are performed by the opening auction element 310. According to embodiments, step 210 may be performed by input element 320, steps 220 and 230 may be performed by vector generator 330, step 240 may be performed by optimizer 340, step 250 may be performed by price determiner 350 and step 260 may be performed by output element 360.

In conclusion, an optimal solution to (LP3) is also an optimal solution to (MIP). (LP3) is a min-cost-flow problem and can be therefore solved in polynomial time by using a min-cost-flow algorithm like the capacity scaling version of the successive shortest path algorithm (cf. J. Edmonds and R. Karp: “Theoretical improvements in algorithmic efficiency for network flow problems”, Journal of the ACM (JACM), 19(2), pages 248 to 264, which is hereby incorporated by reference). A good implementation of this algorithm is available, for instance in the COIN-OR Lemon Graph Library. The present invention provides exact results without any numerical error by using an implementation that is based on long integer numbers. (LP3) may also be solved by the Simplex-Method, but most prior art Simplex-Method implementations are using floating point operations that are exposed to small numerical errors. Further, the inventive method is much faster than prior art pure linear integer programs to solve the opening auction problem for futures contracts. In addition, the present invention is in contrast to prior art techniques not limited to a number of different contracts.

### APPENDIX

Karush-Kuhn-Tucker Conditions:

Let fᵢ,gᵢ,hεC(Rⁿ,R) be linear functions and let the point x* be primal feasible for

max h(x)

s.t. fᵢ(x)≦aᵢ,i=1, . . . ,m[λ]

gᵢ(x)≦bᵢ,i=1, . . . ,k[π] (P)

and λ*,π* dual feasible for

$$\begin{matrix}min {a}^{T} λ + {b}^{T} π \\ s . t {\sum }_{i = 1}^{m} {λ}_{i} ∇ {f}_{i} ( {x}^{*} ) + {\sum }_{i = 1}^{k} {π}_{i} ∇ {g}_{i} ( {x}^{*} ) = ∇ h ( {x}^{*} ) \\ {λ}_{i} \geq 0 , i = 1 , … , m .\end{matrix} \qquad ( D )$$

Then the point x* is primal and (λ*,π*) dual optimal if and only if x*, λ*,π* satisfies the complementary slackness condition (14)

λ*ᵢ(fᵢ(x*)−aᵢ)=0,i=1, . . . ,m. (14)

Note that the derivative of the linear functions f, g and h is independent of x*.

The primal and dual LPs are given by:

$$s . t \begin{matrix}max {d}^{T} y + {c}^{T} x \\ Ay + Bx \leq a [ λ ] \\ Cy + Dx = b [ π ] \\ y \geq 0\end{matrix} s . t \begin{matrix}min {a}^{T} λ + {b}^{T} π \\ {A}^{T} λ + {C}^{T} π \geq d [ y ] \\ {B}^{T} λ + {D}^{T} π = c [ x ] \\ λ \geq 0\end{matrix}$$

The dual problem of (LP1) is given by:

$$min {\sum }_{b ∈ B} {u}_{b} {\overline{v}}_{b} \\ s . t . ∀ b ∈ B {\sum }_{t ∈ T} {q}_{b , t} {p}_{b , t} - {\sum }_{t ∈ T} {q}_{b , t} {π}_{t} = {\overline{v}}_{b} - {\underline{v}}_{b} \\ ∀ b ∈ B {\underline{v}}_{b} , {\overline{v}}_{b} \geq 0 \\ ∀ t ∈ T {π}_{t} free \qquad ( DP 1 )$$

While the invention has been described with respect to the physical embodiments constructed in accordance herewith, it will be apparent to those skilled in the art that various modification, variation and improvements of the present invention may be made in the light of the above teachings and within the purview of the appended claims with out departing from the spirit and intended spirit of the invention. Accordingly, it is to be understood that the invention is not limited by the specific illustrative embodiments, but only by the scope of the appended claims.

1. A computer-implemented method for determining an execution state vector, market clearing prices and bid and ask prices for futures products at an opening auction, wherein a futures product is one of a sell futures contract, a buy futures contract, a sell futures contract combination and a buy futures contract combination, the method comprising:
receiving, by at least one computing device, a plurality of orders, wherein each order is associated with a price limit, a quantity, a participant and a futures product;
determining, by at least one computing device, for each order a quantity vector based on the futures product associated with the order;
determining, by at least one computing device, for each order a price vector based on the price limit associated with the order and the futures product associated with the order;
determining, by at least one computing device, an execution state vector by using the determined price and quantity vectors to maximize an objective function subject to constraints, wherein the objective function is based on an executed volume and wherein at least one of the constraints depends on the determined quantity vectors;
determining, by at least one computing device, market clearing prices and best, not executed, buy and sell orders for each futures product using the execution state vector; and
outputting, by at least one computing device, the determined execution state vector, the determined market clearing prices, and bid and ask prices for each futures product, the bid and ask prices being based on the best, not executed, buy and sell orders of the respective futures product.

2. The computer-implemented method of claim 1, wherein the constraints comprise a clearing constraint and a quantity restriction, the clearing constraint depending on the determined quantity vectors.

3. The computer-implemented method of claim 2, wherein:
the clearing constraint is given by ∀tεT,
$${\sum }_{b ∈ B} {q}_{b , t } , {β}_{b} = 0 ;$$
and
the quantity restriction is given by ∀bεB 0≦β_{b}≦u_{b};
wherein B is a set of orders comprising the plurality of received orders, bεB is an order from the set of orders, T is a set of all futures contracts in the opening auction, tεT is a futures contract from the set of futures contracts, u_{b} is a quantity associated with order b, q_{b,t} is the t-th entry of a quantity vector of a futures product associated with the order b and β_{b} represents an execution state of order b.

4. The computer-implemented method of claim 1, wherein the market clearing prices π are computed by solving:
$$∀ b ∈ B with {β}_{b}^{*} > 0 \text{:} {\sum }_{t ∈ T} ( {p}_{b , t} - {π}_{t} ) {q}_{b , t} \geq 0 , \\ and$$
$$∀ b ∈ B with {β}_{b}^{*} < {u}_{b} \text{:} {\sum }_{t ∈ T} ( {p}_{b , t} - {π}_{t} ) {q}_{b , t} \leq 0 ,$$
wherein the bid and ask prices for each product are computed by selecting the best, non-executed buy and sell orders of the respective futures product; and
wherein β* is the determined execution state vector, B is a set of orders comprising the plurality of received orders, bεB is an order from the set of orders, T is a set of all futures contracts in the opening auction, tεT is a futures contract from the set of futures contracts, u_{b} is a quantity associated with order b, q_{b,t} is the t-th entry of a quantity vector of a futures product associated with the order b and p_{b,t} the t-th entry of a price vector of a futures product that represents the price limit of order b.

5. The computer-implemented method of claim 1, wherein for a futures product (i,j)εT×T associated with an order bεB:
a quantity vector q_{b,T} is determined by:
$${q}_{b , t} = \{ \begin{matrix}+ 1 & if t = i \\ - 1 & if t = j \\ 0 , & otherwise\end{matrix} ;$$
and
a price vector p_{b,T} is determined by:
$${p}_{b , t} = \{ \begin{matrix}price limit of order b & if t = min \{ i , j \} \\ 0 , & otherwise\end{matrix} ,$$
wherein B is a set of orders comprising the plurality of received orders, bεB is an order from the set of orders, T is a set of all futures contracts in the opening auction, tεT is a futures contract from the set of futures contracts, q_{b,t} is the t-th entry of the quantity vector q_{b,T} of a futures product associated with the order b and p_{b,t} the t-th entry of a price vector p_{b,T} of a futures product that represents the price limit of order b.

6. The computer-implemented method of claim 1, wherein determining an execution state vector by using the determined price and quantity vectors to maximize the objective function subject to constraints comprises maximizing the executed volume bounded by a factor, the factor depending on the quantities associated with the orders.

7. The computer-implemented method of claim 6, wherein the factor is
$$V := 1 + {\sum }_{b ∈ B} {u}_{b} ,$$
wherein the objective function is
$$V {\sum }_{b ∈ B} {β}_{b} {\sum }_{t ∈ T} {p}_{b , t } {q}_{b , t} + {\sum }_{b ∈ B} {β}_{b} ,$$
wherein the executed volume is
$${\sum }_{b ∈ B} {β}_{b} ,$$
wherein B is a set of orders comprising the plurality of received orders, bεB is an order from the set of orders, T is a set of all futures contracts in the opening auction, tεT is a futures contract from the set of futures contracts, u_{b} is a quantity associated with order b, q_{b,t} is the t-th entry of a quantity vector of a futures product associated with the order b, p_{b,t} is the t-th entry of a price vector of a futures product that represents the price limit of order b and β_{b} represents an execution state of order b.

8. The computer-implemented method of claim 1, wherein determining an execution state vector by using the determined price and quantity vectors to maximize the objective function subject to constraints comprises:
determining a first execution state vector by maximizing an economic surplus of all participants subject to the constraints, wherein the economic surplus depends on the determined quantity vectors and price vectors; and
determining the execution state vector by maximizing the executed volume subject to the constraints and a further constraint that fixes the economic surplus to the economic surplus of the first execution state vector.

9. The computer-implemented method of claim 8, wherein the economic surplus is
$${\sum }_{b ∈ B} {β}_{b} {\sum }_{t ∈ T} {p}_{b , t } {q}_{b , t} ,$$
wherein we further constraint is
$${\sum }_{b ∈ B}^{ } {β}_{b} {\sum }_{t ∈ T}^{ } {p}_{b , t} {q}_{b , t} = {\sum }_{b ∈ B}^{ } {β}_{b}^{′} {\sum }_{t ∈ T}^{ } {p}_{b , t} {q}_{b , t} ,$$
wherein β′_{b} is the first execution state vector, wherein
$${\sum }_{b ∈ B}^{ } {β}_{b}^{′} {\sum }_{t ∈ T}^{ } {p}_{b , t} {q}_{b , t}$$
is the economic surplus of the first execution state vector, wherein the executed volume is defined by
$${\sum }_{b ∈ B}^{ } {β}_{b} ,$$
wherein B is a set or orders comprising the plurality of received orders, bεB is an order from the set of orders, T is a set of all futures contracts in the opening auction, tεT is a futures contract from the set of futures contracts, q_{b,t} is the t-th entry of a quantity vector of a futures product associated with the order b, p_{b,t} is the t-th entry of a price vector of a futures product that represents the price limit of order b and β_{b} represents an execution state of order b.

10. A computer system, comprising:
at least one processor; and
at least one memory coupled to the at least one processor, wherein the memory comprises processor-executable instructions that, when executed by the at least one processor, cause the at least one processor to determine an execution state vector, market clearing prices and bid and ask prices for futures products at an opening auction, wherein a futures product is one of a sell futures contract, a buy futures contract, a sell futures contract combination and a buy futures contract combination, comprising:
receiving a plurality of orders, wherein each order is associated with a price limit, a quantity, a participant and a futures product;
determining for each order a quantity vector based on the futures product associated with the order;
determining for each order a price vector based on the price limit associated with the order and the futures product associated with the order;
determining an execution state vector by using the determined price and quantity vectors to maximize an objective function subject to constraints, wherein the objective function is based on an executed volume and wherein at least one of the constraints depends on the determined quantity vectors;
determining market clearing prices and best, not executed, buy and sell orders for each futures product using the execution state vector; and
outputting the determined execution state vector, the determined market clearing prices, and bid and ask prices for each futures product, the bid and ask prices being based on the best, not executed, buy and sell orders of the respective product.

11. The computer system of claim 10, wherein the constraints comprise a clearing constraint and a quantity restriction, wherein:
the clearing constraint is given by ∀tεT,
$${\sum }_{b ∈ B}^{ } {q}_{b , t} {β}_{b} = 0 ;$$
and
the quantity restriction is given by ∀bεB 0≦β_{b}≦u_{b};
wherein B is a set of orders comprising the plurality of received orders, bεB is an order from the set of orders, T is a set of all futures contracts in the opening auction, tεT is a futures contract from the set of futures contracts, u_{b} is a quantity associated with order b, q_{b,t} is the t-th entry of a quantity vector of a futures product associated with the order b and β_{b} represents an execution state of order b.

12. The computer system of claim 10, wherein the market clearing prices π are computed by solving:
$$∀ b ∈ B with {β}_{b}^{*} > 0 \text{:} {\sum }_{t ∈ T}^{ } ( {p}_{b , t} - {π}_{t} ) {q}_{b , t} \geq 0 , \\ and$$
$$∀ b ∈ B with {β}_{b}^{*} < {u}_{b} \text{:} {\sum }_{t ∈ T}^{ } ( {p}_{b , t} - {π}_{t} ) {q}_{b , t} \leq 0 ,$$
wherein the bid and ask prices for each product are computed by selecting the best, non-executed buy and sell orders of the respective futures product; and
wherein β* is the determined execution state vector, B is a set of orders comprising the plurality of received orders, bεB is an order from the set of orders, T is a set of all futures contracts in the opening auction, tεT is a futures contract from the set of futures contracts, wherein u_{b} is a quantity associated with order b, q_{b,t} is the t-th entry of a quantity vector of a futures product associated with the order b and p_{b,t} the t-th entry of a price vector of a futures product that represents the price limit of order b.

13. The computer system of claim 10, wherein for a futures product (i,j)εT×T associated with an order bεB:
a quantity vector q_{b,T} is determined by:
$${q}_{b , t} = \{ \begin{matrix}+ 1 & if t = i \\ - 1 & if t = j \\ 0 , & otherwise\end{matrix} ;$$
and
a price vector p_{b,T} is determined by:
$${p}_{b , t} = \{ \begin{matrix}price limit of order b & if t = min \{ i , j \} \\ 0 , & otherwise\end{matrix} ,$$
wherein B is a set of orders comprising the plurality of received orders, bεB is an order from the set of orders, T is a set of all futures contracts in the opening auction, tεT is a futures contract from the set of futures contracts, q_{b,t} is the t-th entry of a quantity vector q_{b,T} of a futures product associated with the order b and p_{b,t} the t-th entry of a price vector p_{b,T} of a futures product that represents the price limit of order b.

14. The computer system of claim 10, wherein determining an execution state vector by using the determined price and quantity vectors to maximize the objective function subject to constraints comprises maximizing the executed volume bounded by a factor, the factor depending on the quantities associated with the orders.

15. The computer system of claim 14, wherein the factor is V:=1+Σ_{bεB}u_{b}, wherein the objective function is
$$V {\sum }_{b ∈ B}^{ } {β}_{b} {\sum }_{t ∈ T}^{ } {p}_{b , t} {q}_{b , t} + {\sum }_{b ∈ B}^{ } {β}_{b} ,$$
wherein the executed volume is
$${\sum }_{b ∈ B}^{ } {β}_{b} ,$$
wherein B is a set of orders comprising the plurality of received orders, bεB is an order from the set of orders, T is a set of all futures contracts in the opening auction, tεT is a futures contract from the set of futures contracts, wherein u_{b} is a quantity associated with order b, q_{b,t} is the t-th entry of a quantity vector of a futures product associated with the order b, p_{b,t} is the t-th entry of a price vector of a futures product that represents the price limit of order b and β_{b} represents an execution state of order b.

16. A non-transitory computer-readable medium having computer-executable instructions that, when executed by a computer, cause the computer to determine an execution state vector, market clearing prices and bid and ask prices for futures products at an opening auction, wherein a futures product is one of a sell futures contract, a buy futures contract, a sell futures contract combination and a buy futures contract combination, comprising:
receiving a plurality of orders, wherein each order is associated with a price limit, a quantity, a participant and a futures product;
determining for each order a quantity vector based on the futures product associated with the order;
determining for each order a price vector based on the price limit associated with the order and the futures product associated with the order;
determining an execution state vector by using the determined price and quantity vectors to maximize an objective function subject to constraints, wherein the objective function is based on an executed volume and wherein at least one of the constraints depends on the determined quantity vectors;
determining market clearing prices and best, not executed, buy and sell orders for each futures product using the execution state vector; and
outputting the determined execution state vector, the determined market clearing prices, and bid and ask prices for each futures product, the bid and ask prices being based on the best, not executed, buy and sell orders of the respective futures product.

17. The computer-readable medium of claim 16, wherein the constraints comprise a clearing constraint and a quantity restriction, wherein:
the clearing constraint is given by ∀tεT,
$${\sum }_{b ∈ B}^{ } {q}_{b , t} {β}_{b} = 0 ;$$
and
the quantity restriction is given by ∀bεB 0≦β_{b}≦u_{b};
wherein B is a set of orders comprising the plurality of received orders, bεB is an order from the set of orders, T is a set of all futures contracts in the opening auction, tεT is a futures contract from the set of futures contracts, u_{b} is a quantity associated with order b, q_{b,t} is the t-th entry of a quantity vector of a futures product associated with the order b and β_{b} represents an execution state of order b.

18. The computer-readable medium of claim 16, wherein the market clearing prices π are computed by solving:
$$∀ b ∈ B with {β}_{b}^{*} > 0 \text{:} {\sum }_{t ∈ T}^{ } ( {p}_{b , t} - {π}_{t} ) {q}_{b , t} \geq 0 , \\ and$$
$$∀ b ∈ B with {β}_{b}^{*} < {u}_{b} \text{:} {\sum }_{t ∈ T}^{ } ( {p}_{b , t} - {π}_{t} ) {q}_{b , t} \leq 0 ,$$
wherein the bid and ask prices for each futures product are computed by selecting the best, non-executed buy and sell orders of the respective futures product; and
wherein β* is the determined execution state vector, B is a set of orders comprising the plurality of received orders, bεB is an order from the set of orders, T is a set of all futures contracts in the opening auction, tεT is a futures contract from the set of futures contracts, u_{b} is a quantity associated with order b, q_{b,t} is the t-th entry of a quantity vector of a futures product associated with the order b and p_{b,t} the t-th entry of a price vector of a futures product that represents the price limit of order b.

19. The computer-readable medium of claim 16, wherein determining an execution state vector by using the determined price and quantity vectors to maximize the objective function subject to constraints comprises:
determining a first execution state vector by maximizing an economic surplus of all participants subject to the constraints, wherein the economic surplus depends on the determined quantity vectors and price vectors; and
determining the execution state vector by maximizing the executed volume subject to the constraints and a further constraint that fixes the economic surplus to the economic surplus of the first execution state vector.

20. The computer-readable medium of claim 19, wherein the economic surplus is
$${\sum }_{b ∈ B}^{ } {β}_{b} {\sum }_{t ∈ T}^{ } {p}_{b , t} {q}_{b , t} ,$$
wherein the further constraint is
$${\sum }_{b ∈ B}^{ } {β}_{b} {\sum }_{t ∈ T}^{ } {p}_{b , t} {q}_{b , t} = {\sum }_{b ∈ B}^{ } {β}_{b}^{′} {\sum }_{t ∈ T}^{ } {p}_{b , t} {q}_{b , t} ,$$
wherein β′_{b} is the first execution state vector, wherein
$${\sum }_{b ∈ B}^{ } {β}_{b}^{′} {\sum }_{t ∈ T}^{ } {p}_{b , t} {q}_{b , t}$$
is the economic surplus of the first execution state vector, wherein the executed volume is defined by
$${\sum }_{b ∈ B}^{ } {β}_{b} ,$$
wherein B is a set of orders comprising the plurality of received orders, bεB is an order from the set of orders, T is a set of all futures contracts in the opening auction, tεT is a futures contract from the set of futures contracts, q_{b,t} is the t-th entry of a quantity vector of a futures product associated with the order b, p_{b,t} is the t-th entry of a price vector of a futures product that represents the price limit of order b and β_{b} represents an execution state of order b.
